(19) United States
(12) Patent Application Publication
(10) Pub. No.: US 2009/0046060 A1
(43) Pub. Date: Feb. 19, 2009

(54) INDICATOR SYSTEM, COMPUTER READABLE RECORDING MEDIUM, AND INDICATING DEVICE

(75) Inventors: Kentaro TAKANO, Kanagawa (JP); Jun SHINGU, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 12/054,526

(22) Filed: Mar. 25, 2008

(30) Foreign Application Priority Data
Aug. 16, 2007 (JP) 2007-212368

(51) Int. Cl. G06F 3/033

(52) U.S. Cl. 345/157

(57) ABSTRACT

An indicator system includes: a controller that transmits, to a terminal, an image in an image capture region that is captured by an image capture unit and includes an object, projects an annotation image relating to the image in the image capture region onto a projecting unit, and switches on and off a power source of the projecting unit in accordance with an instruction with respect to drawing the annotation image.

### CROSS-REFERENCE TO RELATED APPLICATIONS

This application is based on and claims priority under 35 USC 119 from Japanese Patent Application No. 2007-212368 filed Aug. 16, 2007.

### BACKGROUND

1. Technical Field

The present invention relates to an indicator system, a computer readable recording medium, and an indicating device.

2. Related Art

In a conference system or the like, it is necessary to issue instructions with respect to the operation procedures from a terminal side to an object side. As a conference system that can issue such instructions from a terminal side to an object side, there has been an indicator system that transmits an image of an object existing on the object side while capturing the image of the object with video camera, and causes a projector to project an annotation image designated by the terminal in accordance with the captured image, onto the object on the object side.

### SUMMARY

According to an aspect of the invention, there is provided an indicator system including: a controller that transmits, to a terminal, an image in an image capture region that is captured by an image capture unit and includes an object, projects an annotation image relating to the image in the image capture region onto a projecting unit, and switches on and off a power source of the projecting unit in accordance with an instruction with respect to drawing the annotation image.

### BRIEF DESCRIPTION OF THE DRAWINGS

Exemplary embodiments of the present invention will be described in detail based on the following figures, wherein:

FIG. 1 illustrates the structure of a first exemplary embodiment of an indicator system in accordance with the present invention;

FIG. 2 is a functional block diagram showing the components of the server of the indicator system;

FIG. 3 is a flowchart showing an operation to be performed by the server on the object side;

FIG. 4 is a flowchart showing an operation to be performed by the computer of a terminal to form an image;

FIG. 5 shows an example operation to be performed on the terminal side;

FIG. 6 is a flowchart showing an operation to be performed when the power source of the projector is switched on;

FIG. 7 is a flowchart showing an operation to be performed when the power source of the projector is switched off;

FIG. 8 is a flowchart showing another example of an operation to be performed when the power source of the projector is switched off;

FIG. 9 is a flowchart showing another example of an operation to be performed when the power source of the projector is switched off;

FIG. 10 is a flowchart showing an operation to be performed by a server in accordance with a second exemplary embodiment of the present invention;

FIGS. 11A and 11B show output destination attributes that are allotted to annotation images;

FIGS. 12A and 12B show output examples of annotation images that are observed at the terminal and the object;

FIG. 13 is a flowchart showing an operation to be performed when the power source of the projector is switched off in accordance with the second exemplary embodiment; and

FIG. 14 is a functional block diagram showing an example hardware structure of the server.

### DETAILED DESCRIPTION

The following is a description of exemplary embodiments of the present invention, with reference to the accompanying drawings.

### First Exemplary Embodiment

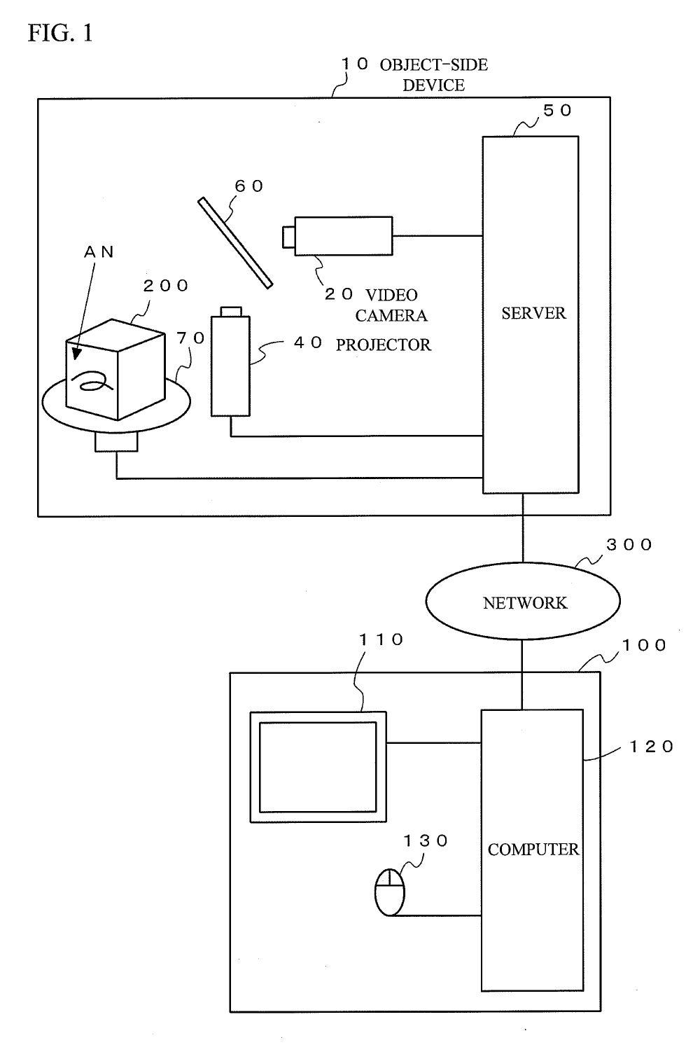

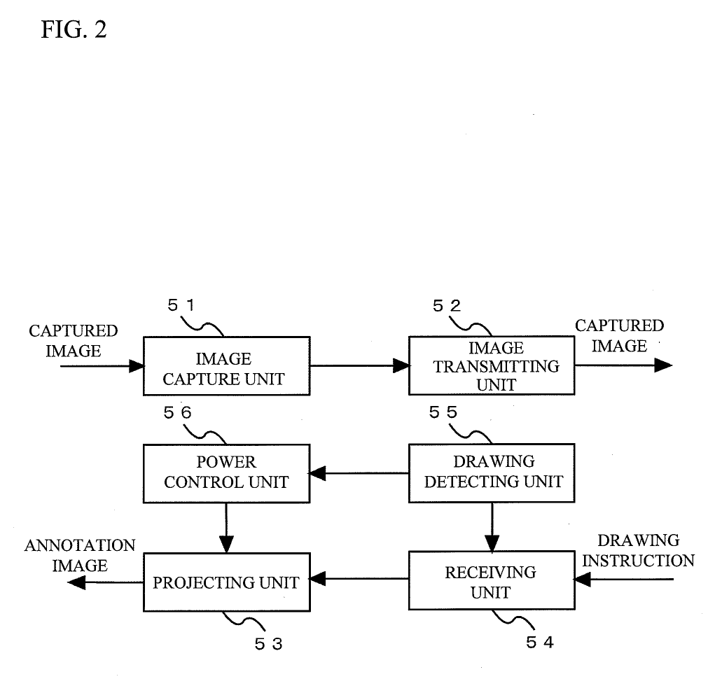

FIG. 1 illustrates the structure of an exemplary embodiment of an indicator system of the present invention. FIG. 2 is a functional block diagram showing the components of the server.

As shown in FIG. 1, this indicator system includes an object-side device 10 and a terminal 100. The object-side device 10 and the terminal 100 are connected by a network 300, so that communications can be made between the object-side device 10 and the terminal 100. Although only one terminal 100 is shown in FIG. 1, terminals 100 and 101 and more may be connected to a server 50 (described later) of the object-side device 10 through the network 300.

The object-side device 10 includes a video camera 20 as an image capture unit, a projector 40 as a projecting unit, a server 50 as a controller, a half mirror 60, and a rotary stage 70 as a relative position changing unit.

The video camera 20 is formed with a CCD camera, for example. The video camera 20 captures an image of an object 200 placed on the rotary stage 70, and the information about the captured image is read in by the server 50. Here, the video camera 20 captures an image transmitted through the half mirror 60.

The projector 40 is formed with a liquid crystal projector, for example. The projector 40 projects an annotation image AN onto the object 200, in accordance with an instruction issued from the terminal 100 based on a captured image. The optical system of the projector 40 is designed to have substantially the same principal point as the video camera 20 by virtue of the half mirror 60. The projector 40 projects an annotation image transmitted from the server 50 onto the object 200 through the optical system and the half mirror 60. The annotation image AN from the projector 40 is reflected by the half mirror 60, and is then projected onto the object 200. The annotation image AN may be an image of any type, such as a line, a character, a figure. The reflectance of the half mirror 60 should preferably be approximately 0.3%.

The rotary stage 70 is controlled by the server 50. The object 200 placed on the upper face of the rotary stage 70 is rotated in at least one of the forward direction and the reverse direction (hereinafter referred to as the rotating operation), so that the position of the object 200 with respect to the video camera 20 and the projector 40 is changed.

The server 50 controls operations of the video camera 20, the projector 40, and the rotary stage 70. The server 50 also exchanges various kinds of information with the terminal 100 through the network 300.

More specifically, the server 50 includes an image capture unit 51 that controls the video camera 20, and an image transmitting unit 52 that transmits an image captured by the video camera 20 to the terminal 100, as shown in FIG. 2. The server 50 also includes a receiving unit 53 that receives an instruction from the terminal 100, and a projecting unit 54 that controls the projector 40 so as to project an annotation image. The server 50 further includes a drawing detecting unit 55 that determines whether the receiving unit 53 has received an instruction with respect to drawing (a drawing instruction), and a power control unit 56 that switches on and off the power source of the projector 40 in accordance with the result of the determination.

With this arrangement, the server 50 transmits an image captured by the video camera 20 to the terminal 100, and causes the projector 40 to project an annotation image AN onto the object 200 in accordance with an instruction issued from the terminal 100 based on the captured image. The server 50 also includes a relative position changing unit (not shown) that controls a change of the annotation image projecting position of the projector 40 with respect to the object 200, in accordance with the rotating operation (movement) of the object 200 by the rotary stage 70.

The terminal 100 includes a display device 110 that is a liquid crystal display or a CRT display or the like, a computer 120 that is connected to the network 300, and a pointing device (a mouse) 130 that is connected to the computer 120.

The display device 110 displays an image transmitted from the object-side device 10 on its display screen.

The pointing device 130 is used for forming an instruction with respect to an annotation image to be projected onto the object 200 through an operation of various buttons with the use of a pointer on the display screen displaying a captured image. The pointing device 130 is also used for issuing an instruction for the operation of rotating the object 200 by the rotary stage 70.

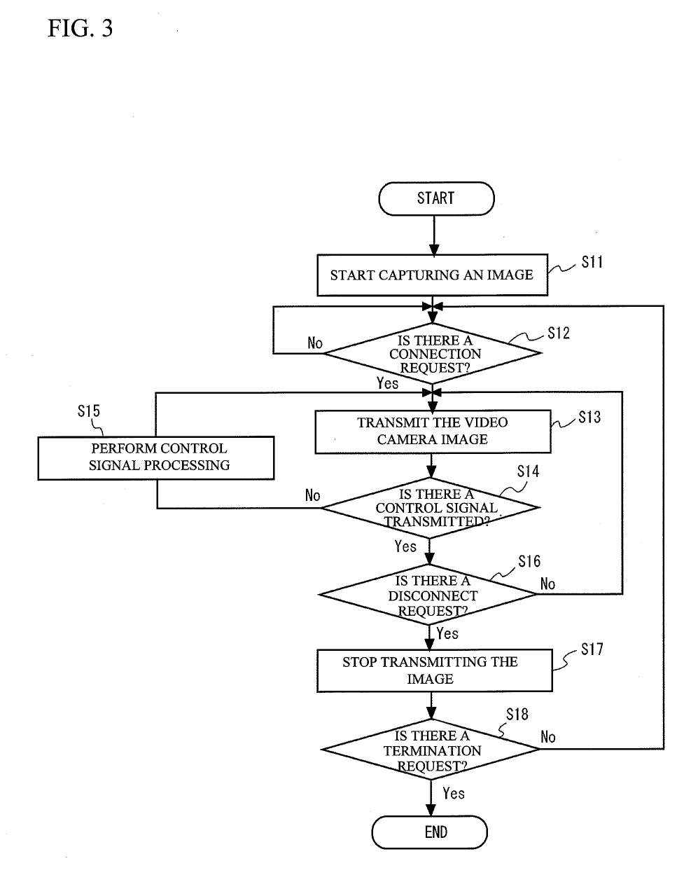

Referring now to FIGS. 3 through 5, operations to be performed by the indicator system having the above described structure are described.

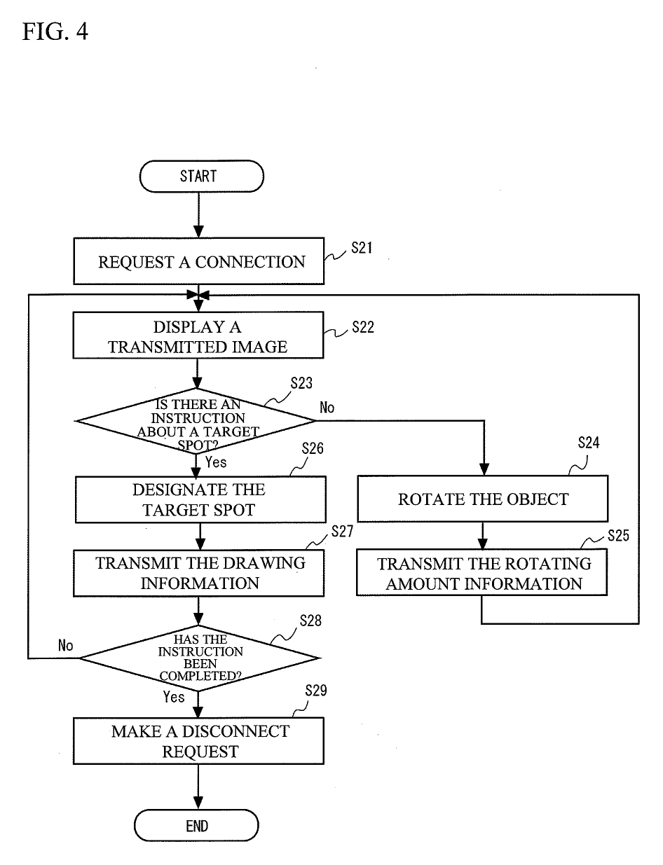

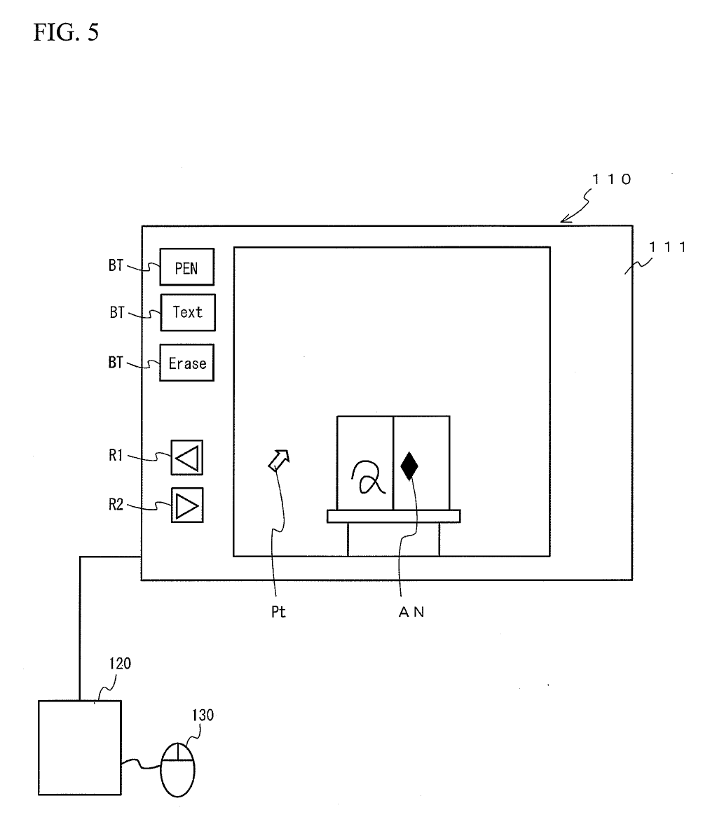

FIG. 3 is a flowchart showing an operation to be performed by the server 50 of the object-side device 10. FIG. 4 is a flowchart showing an image forming operation to be performed by the computer 120 of the terminal 100. FIG. 5 illustrates an operation to be performed in the terminal 100.

As shown in FIG. 3, the server 50 of the object-side device 10 starts capturing an image captured by the video camera 20 (an image in a capture region that is captured by the video camera 20 and includes an object) (step S11), and determines whether there is a connection request from the computer 120 of the terminal 100 (step S12). If there is a connection request from the computer 120, the server 50 transmits the image captured by the video camera 20 to the computer 120 of the terminal 100 through the network 300 (step S13).

The server 50 next determines whether there is a control signal transmitted from the computer 120 (step S14). This control signal serves as a drawing signal carrying the information about drawing an annotation image, and as a position control signal for rotating the rotary stage 70. If there is such a control signal, the server 50 performs “control signal processing” in accordance with the contents of the control signal (step S15).

If there is not a control signal, the server 50 determines whether there is a disconnect request from the computer 120 (step S16). If there is not a disconnect request, the server 50 returns to step S13, and transmits a new captured image to the computer 120 of the terminal 100 through the network 300. If there is a disconnect request, the server 50 stops transmitting the image captured by the video camera 20 (step S17). The server 50 then determines whether there is a termination request (step S18). If there is not a termination request, the server 50 returns to step S12, and repeats the above procedures. If there is a termination request, the server 50 ends the operation.

Next, an operation to be performed in the terminal 100 is described. As shown in FIG. 4, the computer 120 of the terminal 100 first sends a connection request to the server 50 (step S21). After a connection is established, the computer 120 displays a captured image transmitted from the server 50 on the object side, on the display screen 111 of the display device 110 (step S22).

The computer 120 then determines whether there is an instruction from the operator with respect to a target spot in the captured image displayed on the display screen 111 of the display device 110 (step S23). If there is an instruction about a target spot, the computer 120 performs an operation in accordance with the instruction (step S26) More specifically, the operator of the terminal 100 examines the image displayed on the display screen 111 of the display device 110 as shown in FIG. 5. If the displayed image includes a target spot on which an annotation image is to be projected, the operator of the terminal 100 handles the pointing device 130 and moves a pointer Pt on the display screen 11, so as to indicate the target spot. A “target spot” is a spot that defines the projecting position onto which an annotation image AN is to be projected. Here, the information about the annotation image to be projected onto the target spot is also indicated.

The information about the annotation image may be graphic information such as a rectangular or circle that is drawn by operating various buttons BT and the likes formed on the display screen 111 with the use of the pointing device 130, a bitmap image that is prepared in advance, text information that is input through a keyboard or the like, or the pointer that reflects the movement of the pointing device 130, for example. The computer 120 then transmits the various kinds of information determined in step S26 as the drawing information to the server 50 (step S27).

The computer 120 next determines whether the instruction that is issued from the terminal 100 by the operator based on the image captured by the video camera 20 has been completed (step S28). If the instruction has been completed, the computer 120 sends a disconnect request to the server 50 (step S29), and then ends the operation. If the instruction issued by the operator of the terminal 100 has not been completed, the computer 120 returns to step S22, and repeats the above procedures.

When the operator of the terminal 100 wishes to rotate the object 200, the operator looks at the image displayed on the display screen 111 shown in FIG. 5, and clicks rotating buttons R1 and R2 that are formed on the display screen 111 and are designed to rotate the rotary stage 70. By clicking the rotating buttons R1 and R2, the operator designates the rotating direction and the rotating amount of the rotary stage 70, so that the spot on the object 200 on which an annotation image is to be projected is displayed within the image, or an optimum viewpoint can be achieved with respect to the object 200. If there is not an instruction about a target spot (an instruction about an annotation image) in step S23, the computer 120 determines that the operator of the terminal 100 issues an instruction about the rotation of the object 200, and performs processing about the rotation of the object 200 (step S24).

The computer 120 then transmits the rotating amount information (movement amount information) obtained through the processing about the rotation of the object 200, to the server 50 on the object side (step S25). As a result, the rotary stage 70 is rotated to change the rotating position of the object 200, and a new captured image is displayed on the display device 110 of the terminal 100 (step S22).

Next, various operations to be performed when drawing an annotation image is detected are described.

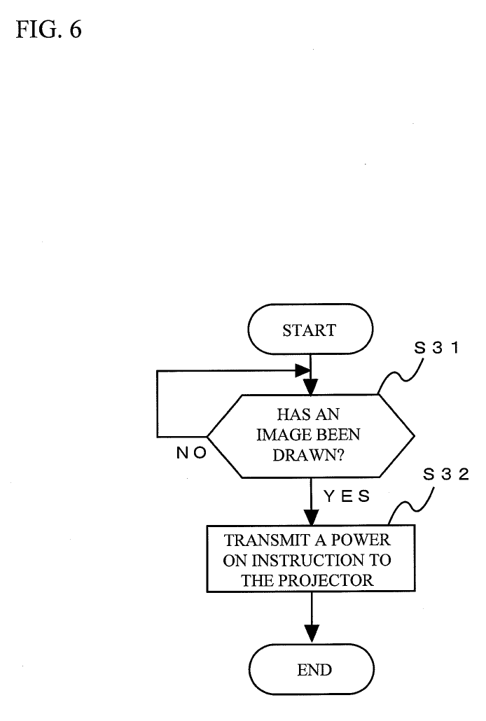

FIG. 6 is a flowchart showing an operation to be performed when the power source of the projector 40 is switched on.

First, the user uses the pointing device 130 or the like on the terminal 100, to issue an instruction to draw an annotation image AN.

If the server 50 determines that an annotation image has been drawn by the terminal 100 (step S31), the server 50 switches on the power source of the projector 40 (step S32). As the power source of the projector 40 is switched on independently of the power source of the indicator system, exhaustion of the power source of the projector can be prevented.

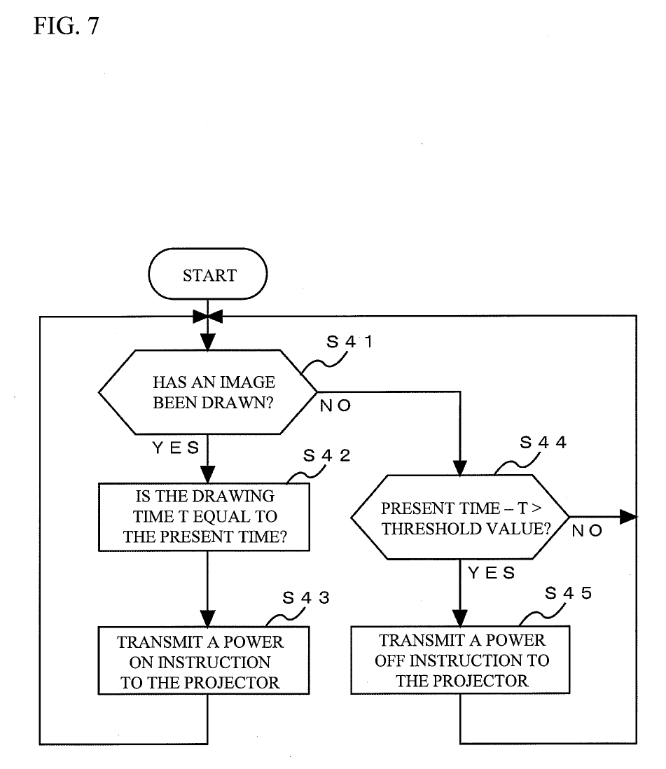

FIG. 7 is a flowchart showing an operation to be performed when the power source of the projector 40 is switched off.

First, the user uses the pointing device 130 or the like on the terminal 100, to issue an instruction to draw an annotation image AN.

If the server 50 determines that an annotation image has been drawn by the terminal 100 (step S41), the server 50 sets the drawing time T as the present time (step S42), and switches on the power source of the projector 40 (step S43). The server 50 then returns to step S41. If the power source of the projector 40 has already been switched on, the procedure of step S43 may be skipped.

If the server 50 determines that an annotation image has not been drawn by the terminal 100 while the power source of the projector 40 is on (step S41), the server 50 determines whether the requirement “(present time−T)>threshold value” is satisfied (step S44). If the requirement is satisfied, the server 50 switches off the power source of the projector 40 (step S45), and returns to step S41.

Here, the threshold value is used for determining a period of time during which drawing is not performed. The threshold value can be arbitrarily set, and may be 30 minutes, for example. Accordingly, if an instruction about drawing an annotation image is not issued for a predetermined period of time, the power source of the projector 40 can be switched off.

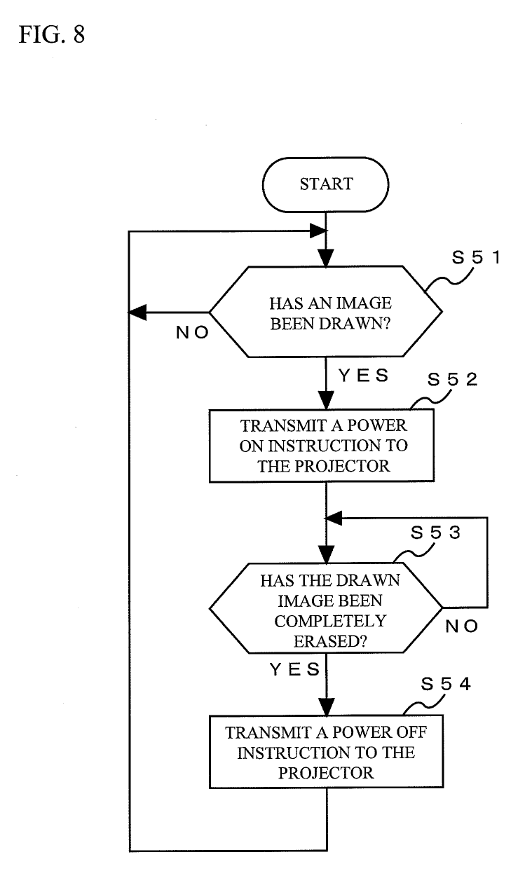

FIG. 8 is a flowchart showing another operation to be performed when the power source of the projector 40 is switched off.

First, the user uses the pointing device 130 or the like on the terminal 100, to issue an instruction to draw an annotation image.

If the server 50 determines that an annotation image has been drawn by the terminal 100 (step S51), and switches on the power source of the projector 40 (step S52).

If the server 50 determines that an entire annotation image has been erased by the terminal 100 (step S53), the server 50 switches off the power source of the projector 40 (step S54). Accordingly, in a case where an annotation image has not been projected, the power source of the projector 40 can be switched off.

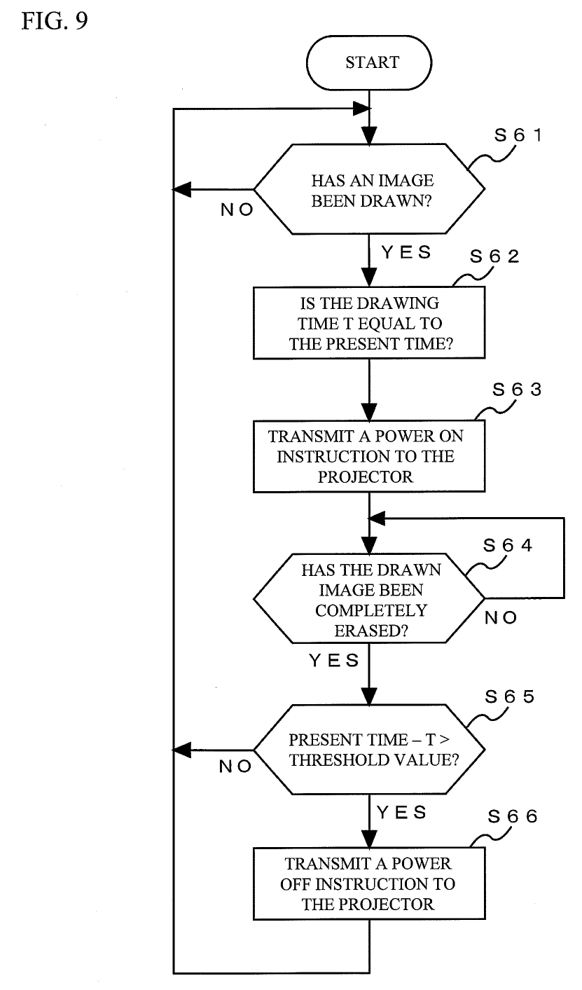

It is also possible to combine the power control operations for the projector 40 shown in FIGS. 7 and 8. FIG. 9 is a flowchart that combines the flowchart of FIG. 7 and the flowchart of FIG. 8. In accordance with the flowchart of FIG. 9, in a case where an instruction to draw an annotation image AN has not been issued for a predetermined period of time, the server 50 can switch off the power source of the projector 40, and, in a case where the entire projection of the annotation image AN has been erased, the server 50 can also switch off the power source of the projector 40.

In the above described exemplary embodiment, the server 50 switches on and off the power source of the projector 40 in accordance with an instruction or the like to draw an annotation image AN. However, when an instruction to switch on the power source of the projector 40 is transmitted from the terminal 100 to the server 50, the server 50 may switch on the power source of the projector 40 upon receipt of the instruction. The same arrangement may be employed for switching off the power source. In this manner, exhaustion of the projector 40 can be prevented.

### Second Exemplary Embodiment

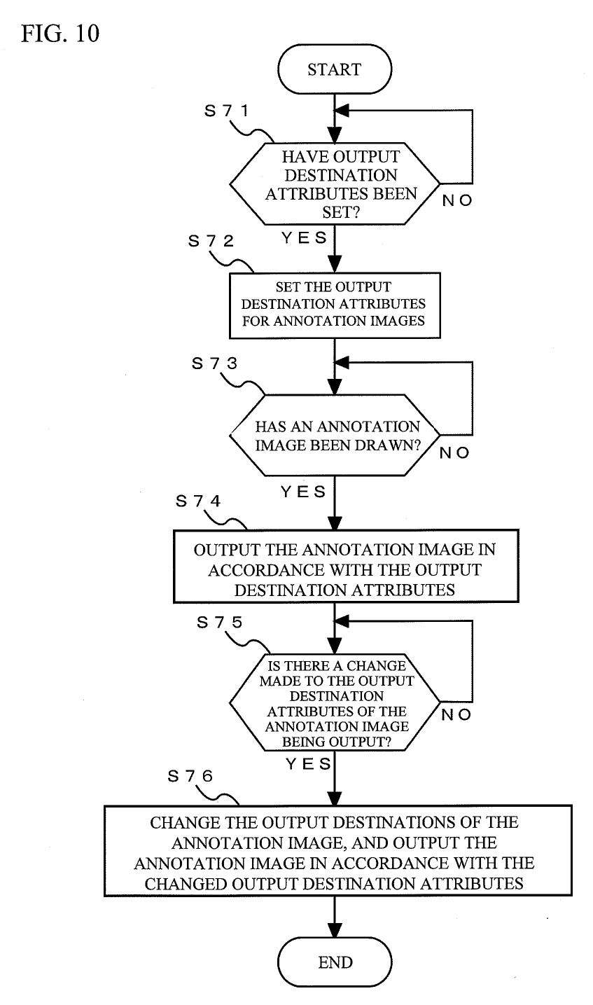

Referring now to FIGS. 10 through 12B, a second exemplary embodiment of the present invention is described in detail.

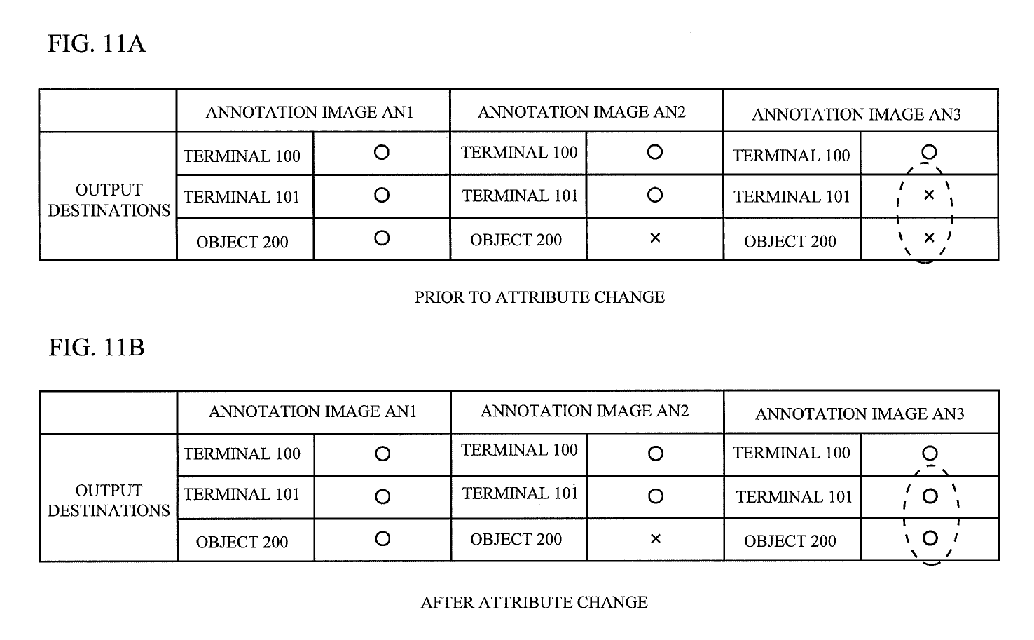

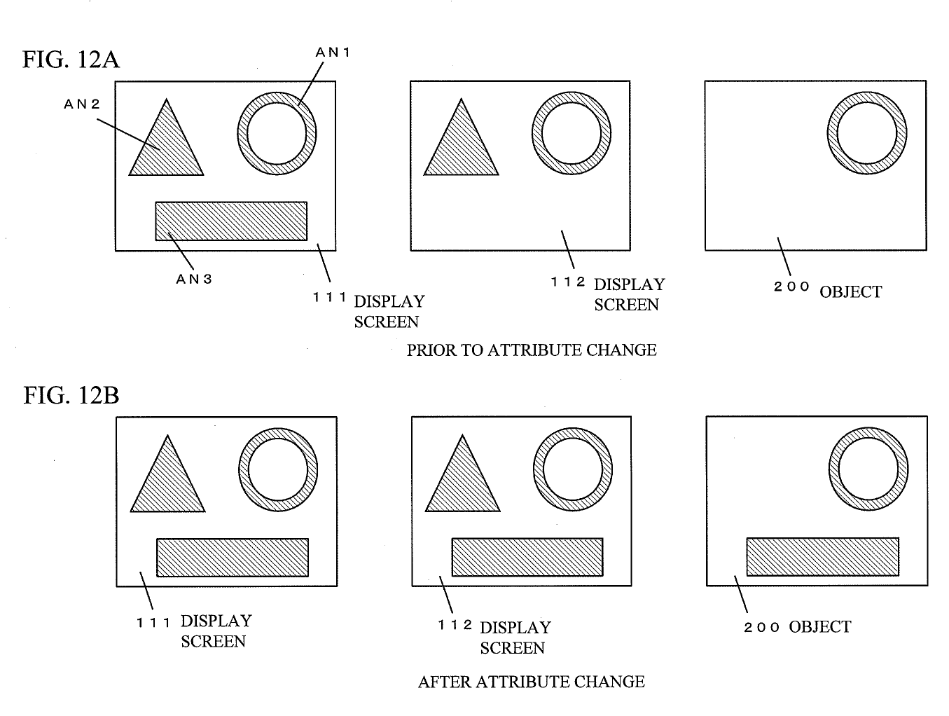

FIG. 10 is a flowchart showing an operation to be performed by the server 50. FIGS. 11A and 11B are tables showing the attributes of output destinations that are included in an annotation image. FIGS. 12A and 12B show output examples of annotation images that are seen at the terminal 100 and the object 200. More specifically, FIGS. 12A and 12B show output examples of annotation images displayed on the display screens 111 and 112 of the terminal 100 and the terminal 101 (not shown), and output examples of annotation images projected on the object 200. Here, “output” may be either “display” or “project”.

As shown in FIG. 10, the server 50 first determines whether an attribute has been set by the terminal 100 for the output destination of each annotation image (hereinafter referred to as the “output destination attribute”) (step S71). In a case where the output destination attributes have been set by the terminal 100, the server 50 also sets the output destination attributes for annotation images (step S72).

More specifically, as shown in FIG. 11A, the server 50 sets an output destination attribute for each annotation image in accordance with instructions from the terminal 100. For example, FIG. 11A indicates that an annotation image AN1 is to be output to the terminal 100, the terminal 101, and the object 200. FIG. 11A also indicates that an annotation image AN3 is to be output only to the terminal 100.

The server 50 then determines whether an annotation image has been drawn (step S73). In a case where an annotation image has been drawn, the server 50 outputs the annotation image in accordance with the output destination attribute of the annotation image (step S74).

More specifically, in a case where the output destination attributes as shown in FIG. 11A have been set for the respective annotation images AN1, AN2, and AN3 to be output, the annotation images AN1, AN2, and AN3 are output as shown in FIG. 12A. The annotation images AN1, AN2, and AN3 are output to the display screen 111 of the terminal 100. The annotation images AN1 and AN2 are also output to the display screen 112 of the terminal 101. Only the annotation image AN1 is also output to the object 200.

The server 50 then determines where there is a change made to the output destination attributes of the annotation images AN1, AN2, and AN3 that are being output (step S75). If there is a change made to the output destination attributes, the server 50 changes the output destinations of the annotation images in accordance with the changed output destination attributes, and outputs the annotation images (step S76).

For example, in a case where the output destination attributes of the annotation images shown in FIG. 11A are changed to the output destination attributes of the annotation images shown in FIG. 11B, or in a case where the output destination attribute of the annotation image AN3 is changed from the terminal 100 to the terminal 100, the terminal 101, and the object 200, the annotation image AN3 is also output to the display screen 112 of the terminal 101 and the object 200, as shown in FIG. 12B.

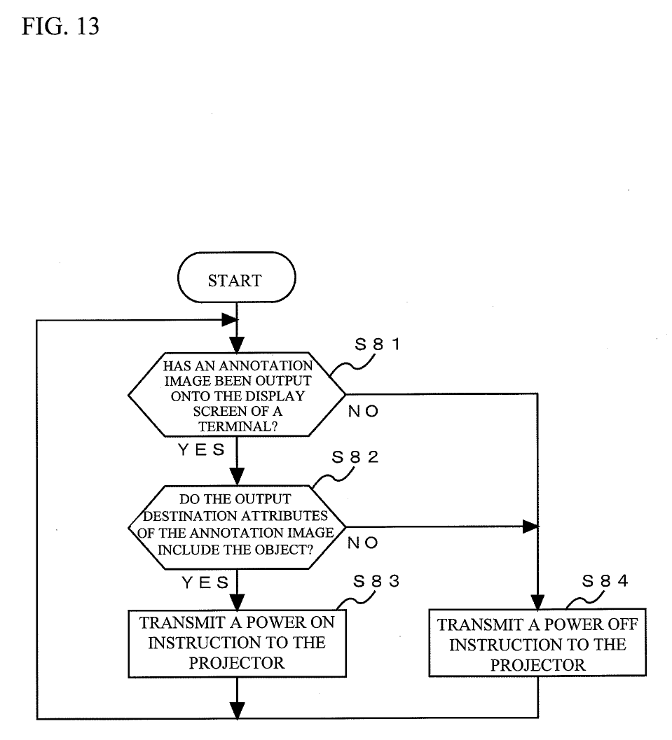

Referring now to FIG. 13, an operation to be performed to switch off the power source of the projector 40 in accordance with the second exemplary embodiment is described. FIG. 13 is a flowchart showing an operation to be performed when the power source of the projector 40 is switched off.

As shown in FIG. 13, the server 50 first determines whether annotation images have been output to the display screens of all the terminals (step S81). In a case where an annotation image has been output to the display screen of one of the terminals, the server 50 determines whether the output destination attributes of the annotation image include the object 200 (step S82).

In a case where the output destination attributes of the annotation image include the object 200, the server 50 transmits an instruction to the projector 40 to switch on its power source (referred to as a “power ON instruction” in FIG. 13) (step S83). In a case where the power source has already been switched on, the procedure of step S83 may be skipped.

In a case where the output destination attributes do not include the object 200, the server 50 transmits an instruction to the projector 40 to switch off its power source (referred to as a “power OFF instruction” in FIG. 13) (step S84). This is because, when the output destination attributes do not include the object 200 but do include the terminal 100 or the terminal 101, the server 50 does not need to activate the projector 40 and should output the annotation image only to the display screen 111 of the terminal 100 or the like. Accordingly, in a case where an annotation image is to be output only to the display screen 111 of the terminal 100, the server 50 may switch off the power source of the projector 40.

Although exemplary embodiments of the present invention have been described so far, the present invention is not limited to the above described specific exemplary embodiments, and various changes and modifications may be made to them within the scope of the claimed invention. For example, a program in accordance with the present invention may be provided through a communication means, or may be recorded on a recording medium such as a CD-ROM.

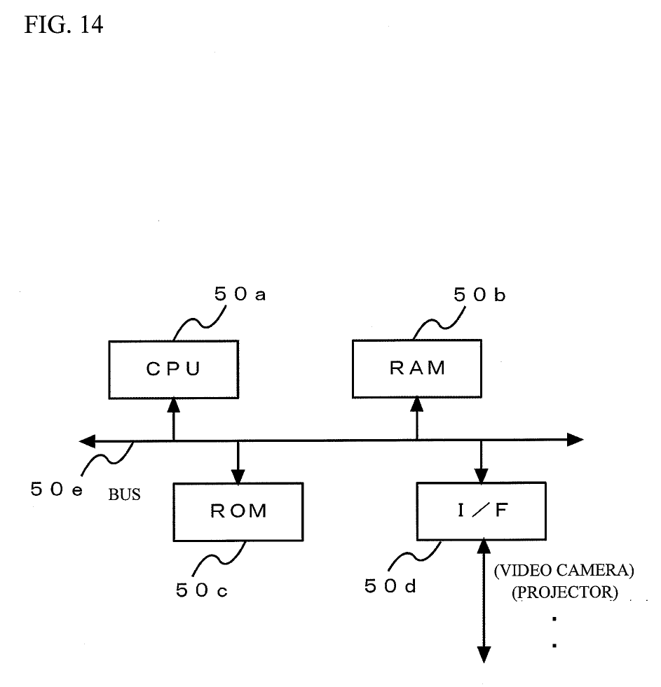

The above described server 50 may be embodied by a computer or a hardware structure shown in FIG. 14. In the hardware structure shown in FIG. 14, a processor such as a CPU 50a, a RAM 50b such as a SRAM (Static Random Access Memory), a DRAM (Dynamic RAM), a SDRAM (Synchronous DRAM), or a NVRAM (Non-Volatile RAM), a ROM (Read Only Memory) 50c such as a flash memory, an interface 50d that performs input and output operations with an external device such as an input device or a display device, and a magnetic disk such as a hard disk (not shown) are connected to one another by a bus 50e.

The CPU 50a reads an appropriate program recorded on the ROM 50c or the hard disk or the like, and performs an operation in accordance with the program so as to realize the functions of the server 50. Here, the program may be a program for carrying out the procedures shown in the above described flowcharts. The same applies to the computer 120.

Also, in the above described exemplary embodiments, the power source of the projector 40 may be switched off gradually or little by little in a predetermined period of time, or the output of the projector 40 may be gradually attenuated. In this manner, exhaustion of the projector 40 can also be prevented.

In accordance with the present invention, the power source of the projector is switched on and off in accordance with instructions about drawing annotation images, so as to prevent exhaustion of the projector. Thus, the present invention has high industrial applicability.

What is claimed is:

1. An indicator system comprising:
a controller that transmits, to a terminal, an image in an image capture region that is captured by an image capture unit and includes an object, projects an annotation image relating to the image in the image capture region onto a projecting unit, and switches on and off a power source of the projecting unit in accordance with an instruction with respect to drawing the annotation image.

2. The indicator system according to claim 1, wherein the controller switches on the power source of the projecting unit, when an instruction to draw the annotation image is detected.

3. The indicator system according to claim 1, wherein the controller switches off the power source of the projecting unit, when an instruction to draw the annotation image is stopped over a predetermined period of time.

4. The indicator system according to claim 1, wherein the controller switches off the power source of the projecting unit, when an end of all the drawing of the annotation image is detected.

5. The indicator system according to claim 1, wherein the controller off the power source of the projecting unit, when an end of the drawing of the annotation image on the object is detected.

6. The indicator system according to claim 3, wherein the controller gradually switches off the power source of the projecting unit.

7. A computer readable recording medium causing a computer to execute a process for performing an indicating operation, the process comprising:
transmitting, to a terminal, an image in an image capture region that is captured by an image capture unit and includes an object;
projecting an annotation image relating to the image in the image capture region onto a projecting unit; and
switching on and off a power source of the projecting unit in accordance with an instruction with respect to drawing the annotation image.

8. An indicating device comprising:
an image capture unit that captures an image of an object;
a projecting unit that projects an annotation image representing an annotation onto a spot within an image capture region of the image capture unit, in accordance with an instruction issued based on the captured image; and
a controller that switches on and off a power source of the projecting unit in accordance with an instruction with respect to drawing the annotation image.
